(19) United States
(12) Patent Application Publication
(10) Pub. No.: US 2011/0278833 A1
(43) Pub. Date: Nov. 17, 2011

(54) Structure of a Ticket, Particularly for the Entrance to Events and Shows, for Contests, Promotional Operations or Similar

(75) Inventor: Dario Pozzi, Milano (IT)

(73) Assignee: HERA S.A.S. DI DARIO POZZI & C., Milano (IT)

(21) Appl. No.: 13/107,536

(22) Filed: May 13, 2011

(30) Foreign Application Priority Data
May 14, 2010 (IT) MI2010A000860

(51) Int. Cl. B42D 15/00

(52) U.S. Cl. 283/53

(57) ABSTRACT

An admission ticket, having a main body and a stub, is formed of two superimposed sheets coupled to each other by at least two bands of adhesive arranged along lateral edges which are parallel to each other and also parallel to the separation line between the main body and the stub. A weakening, such as a punched perforation, forms the separation line in order to facilitate the detachment of the stub from the main body. At least one of the sheets carries control data on its inner side, referring to a contest, promotional operations, dynamic advertising, anti-counterfeiting or other information.

This invention refers to a structure of a ticket, particularly for the entrance to events and shows.

As it is known, to enter a play or show, as a theatre, a concert, a movie show, a sporting event, etc. a so-called ticket is exhibited.

The tickets often comprise a detachable stub which is held and/or separated by the control staff at the entrance.

Sometimes the tickets are also used as advertising items, and in addition to specific data relating to the show, have statements and promotional figures.

Task of the present invention is to realize a ticket structure, particularly suitable for the use for shows and similar, which has a detachable stub and at the same time can be used for contests, promotional operations or similar.

A main purpose of the invention is to realize a structure of a ticket which can be managed as a continuous strip of single elements wound onto a reel or accordion-folded. Each ticket is formed by a main body or matrix and a stub placed adjacent to and above the main body. This position facilitates the continuous printing of traditional tickets with the standard equipment still existing. For printing the tickets, we mean both the preliminary printing of information, news and advertising before the delivery to the user, for example to the person organizing the show, as well as the subsequent printing at the moment of the use of the ticket (containing the data of the show, the number of seats, the generality of the audience, etc.) for validating an entrance ticket to entertainment places and events in general or in the stage of obliteration to access to various visit places as amusement parks.

Another purpose of the invention is to provide a structure of an entrance ticket, particularly for any kind of events and shows, comprising a main body associated with a detachable stub above the main body. The detachable stub is integral with the main body and is separated from the same by means of a longitudinal punched line facilitating its detachment.

The entire ticket is normally made of two overlapping sheets coupled in a suitable way. In some cases the stub could also be formed by just one sheet.

At least one of the sheets of the main body brings on the inside indications relating to a contest or to events in which the same is used.

The two sheets of the main body are joined together by means of one or more longitudinal adhesive bands, by considering the direction of unwinding the strip of tickets, which adhesive bands prevent a separation of the sheets themselves when the detachable stub is still associated to the main body. Only the separation of the body of the ticket from the stub permits to see the information contained inside the ticket, when the adhesive is applied only to the two upper and lower bands of the ticket.

Folders of lottery are already known, realized according to U.S. Pat. No. 4,174,857 and ES-8,401,384.

U.S. Pat. No. 4,174,857 in the name John R. Koza relates to a lottery folder, unsuitable for being used as an entrance ticket as specified before. The information data are shown on the base sheet and such data are further hidden by an overlying layer of an opaque material. It is made at least by one base sheet and a cover sheet joined together by means of an adhesive on all four sides. In order to access to the data and verify is the folder is winning, three peripheral punched edges of the folder must be ripped so making the data visible. One of the defects of this kind of folder is due to the waste of paper made by the marginal paper strips from the outer edges of the tickets up to the ripping perforations which are thrown away maybe on the floor, so causing an environmental degradation. In case of winning one portion of the folder with the data is detached and the remaining portion also containing the same data is viewed by the competent authority in order to compare such data and validate the winning. The lottery folder cannot be modified for the use as an entrance ticket to shows or amusement places, as the detached portion cannot be used as an authorization for the access to a room or region and as an access validation in a plurality of points of endorsement of the amusement parks and over all the detachment of just one portion would not permit to open and view the message printed inside. The upper sheet just serves to hide the data printed on the base sheets and cannot be used as an entrance ticket. The sealing on four sides hinders the subsequent printing of the air kept between the two sheets, not being able to escape, forms an air bubble and therefore a thickening of the folder which finally makes the printer jam. Furthermore eliminating the edges along the perforation the dimensions of the folder are reduced, so a passage of the folder into an endorsing machine in order to have access to other sideshows is made impossible.

Patent ES-8,401,384 always at the name of Johr R. Koza describes a method for realizing the lottery folder described in U.S. Pat. No. 4,174,857, having the disadvantages and drawbacks indicated before if used as a ticket for shows, amusement parks and similar.

Further characteristics and advantages of the subject of the present invention will be more evidenced through an examination of a preferred but non exclusive embodiment of the invention, illustrated in an indicative and non limiting way in the annexed drawings, in which:

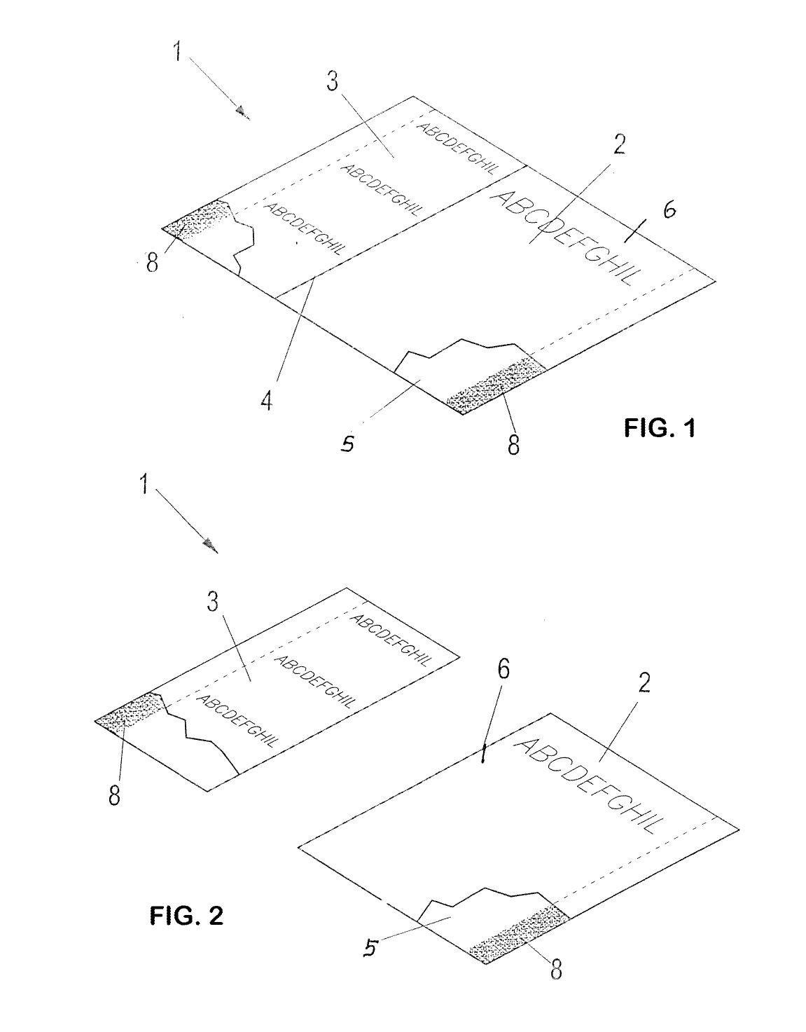

FIG. 1 is a perspective view of a structure of a ticket according to the present invention, illustrated in closed conditions and with the stub attached to the body of the ticket;

FIG. 2 is a perspective view which shows the structure in the condition in which the stub has been separated from the body of the ticket;

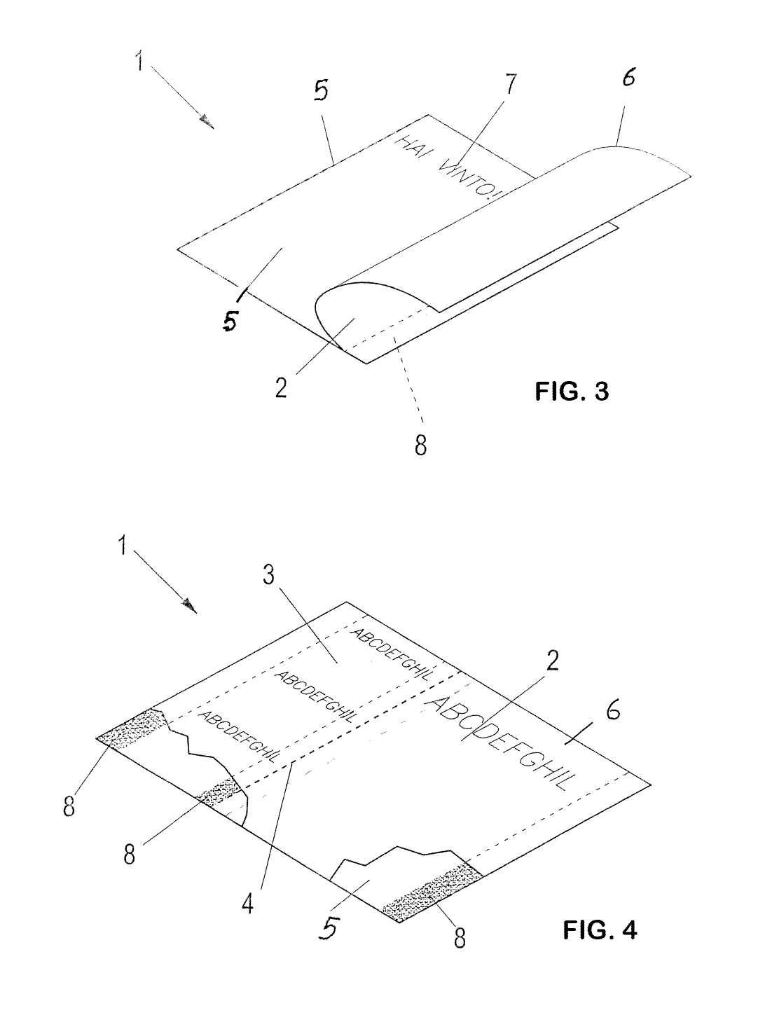

FIG. 3 is a perspective view showing the structure in the condition in which the body of the ticket has been separated from the stub; the body of the ticket has been opened in order to verify the winnings, or the phases of the promotional operation and similar;

FIG. 4 is a perspective view of the structure of the ticket in which the stub is not separated from the body of the ticket; the latter has two bands with glue on two of its ends;

FIG. 5 is a perspective view of a plurality of tickets associated one to the other and outstretched, in the condition in which they are produced by a printing or dispensing machine;

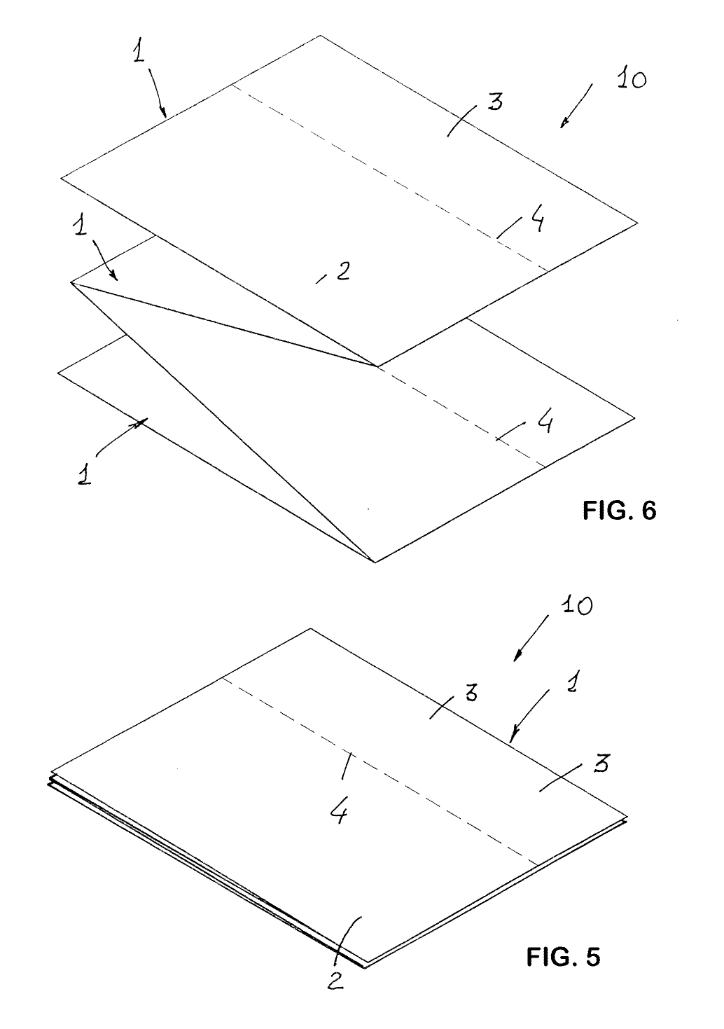

FIG. 6 is a perspective view showing a plurality of tickets attached one to the other, in the act of being folded like an accordion;

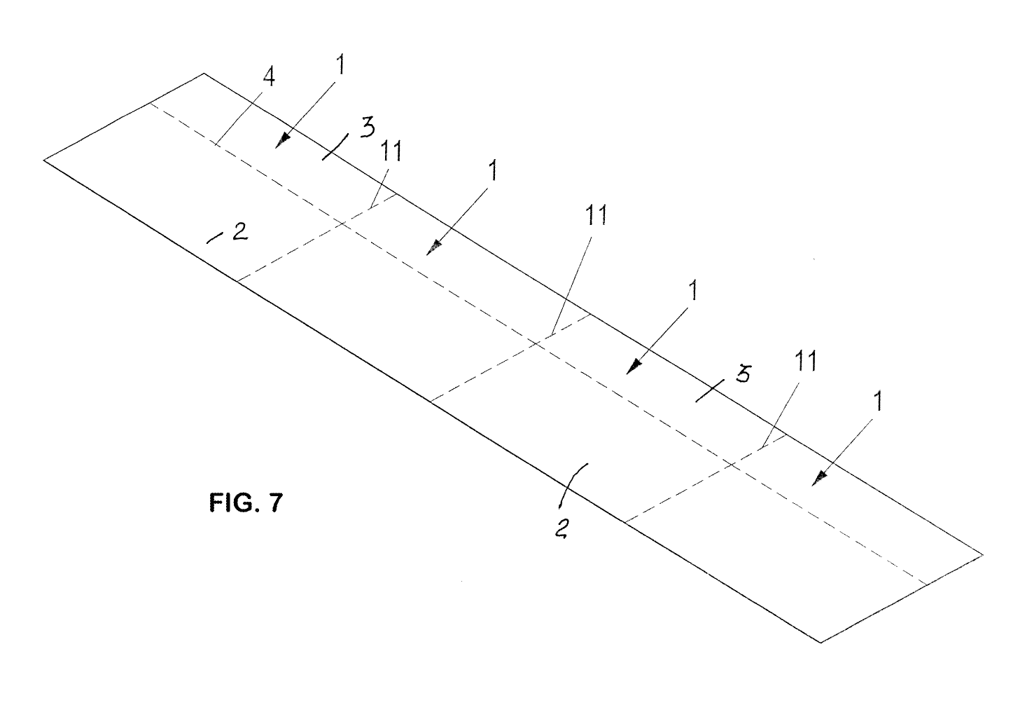

FIG. 7 shows a group of mutually connected tickets.

With particular reference to the reference numbers of the aforementioned figures, the structure of an entrance ticket, particularly for events, shows and for contests, according to the invention, globally indicated with the reference number 1, comprises a main body 2, associated to a detachable stub 3.

The detachable stub 3 is realized in a single piece with the main body 2 and is separated from the same through a punched longitudinal line 4.

According to the present invention, the main body 2 is made of two coupled sheets, respectively indicated with the reference characters 5 and 6, at least one of which, the sheet 5 for example, carries on its inside indications 7 referring to a contest or another event.

The two sheets 5 and 6 are joined together by means of adhesive lateral bands 8 which prevent a separation of the sheets 5 and 6, when the detachable stub 3 is still associated to the main body 2.

A suitable masking also prevents revealing the indications 7 by placing for example the ticket against a source of light.

The detachable stub could be made as a variation, by a single sheet instead of two as the main body.

The structure of ticket 1 is produced by a reel or an accordion-folded strip, non visible in the figures, contained in a suitable dispensing and printing equipment, which is able to dispense one or more structures of tickets 1, associated through punched areas 11, and which make one group 10, visible in FIG. 7.

The tickets 1 can be immediately separated for their use. However, if it must not be used immediately, the group of tickets can be bent like an accordion, by using the punched lines 11 as can be seen in FIG. 6, and compacted, as seen in FIG. 5, virtually occupying the space of just one ticket and making the transfer in the pocket or in a wallet more easy.

It must be stated that inside the ticket, in addition to mentions referring to contests, promotional operations, dynamic advertising and similar activities, like safety and anti-counterfeiting prints can also be inserted.

In particular, alphanumeric codes can be printed, prints with special paints, etc.

In this case it is also necessary to have a detachable stub, which can be opened in order to see the contents of the coupled sheet.

The stub itself, in order to make it more strong, can present a double sticking 8, at both sides or also a single sticking and can also be opened.

The various tickets are produced stick together, but afterwards, in relation to the kind of dispensing machine (printer) they are finished by bending or rolling.

The accordion-like packaging is suitable to charge in a dispensing machine, like it occurred in the old printers with continuous module.

In the structure of ticket provided with just two bands of glue and illustrated in FIG. 2, when the tear of the stub occurs, both parts, respectively of the ticket 3 and of the stub 2, open so making visible the contents printed on the inner sheet 5.

Therefore, according to this invention, a structure of ticket has been in fact realized which can advantageously be used for contests and similar activities, thanks to the possibility of inserting hidden indications which can be detected only at the moment in which the ticket is used.

The structure of ticket according to the present invention also comprises a detachable stub, useful for a checking by the staff, and which acts like a seal in the case of the contest associated to the ticket itself.

Another advantage of the present invention is given by the possibility of bending and compacting a plurality of tickets, without damaging the single ticket of the group, in order to make its transport easy.

Naturally the used materials, and also their dimensions, can be of any kind, according to the needs. It can be stated that, an exemplary but not limitative embodiment of the invention having here been described, the present invention is susceptible of numerous modifications and variations all within the inventive concept expressed in the annexed claims, whereas the technical details can vary according to the particular needs and to the state of the art.

1. An admission ticket
comprising two superimposed sheets joined to each other,
said ticket having two separable contiguous parts which form a main body and a stub,
the two sheets being coupled to each other by at least two parallel bands of adhesive arranged at least along its lateral edges which are parallel to each other and also parallel to the separation line between the main body and the stub,
a weakened zone being provided along said separation line in order to facilitate the detachment of the stub from the main body, wherein
at least one of said sheets carries on its inner side control data, indications referring to a contest, promotional operations, dynamic advertising or anti-counterfeiting or other information.

2. The ticket according to claim 1, wherein the two sheets of the main body are joined together by means of at least one lateral adhesive band which prevents the separation of the sheets themselves, and opening and reading said information, while the detachable stub is still associated to the main body.

3. The ticket according to claim 1, wherein the main body part of the ticket is provided with two adhesive lateral bands.

4. The ticket according to claim 1, wherein the stub is made by two overlaying and coupled bodies.

5. The ticket according to claim 4, wherein the two sheets of the stub are joined together by means of at least one lateral adhesive band which prevents separation of the sheets themselves while the detachable stub is still associated to the main body.

6. The ticket according to claim 4, wherein the two sheets of the stub part of the ticket are provided with two adhesive lateral bands.

7. The ticket according to claim 1, wherein a group of such tickets are produced in a continuous strip in which said tickets are interconnected and can also be separated the ones from the others along transverse perforations.

8. The ticket according to claim 7, wherein the group of tickets are bent and accordion-packed along the transversal perforations, virtually occupying the space of just one ticket.

9. The ticket according to claim 1, wherein masking is applied to at least one of the sheets to prevent one from viewing the information by putting the ticket against a light.

10. The ticket according to claim 7, wherein the group of tickets are wound into a roll of tickets.
